(19) United States
(12) Patent Application Publication
(10) Pub. No.: US 2018/0051678 A1
(43) Pub. Date: Feb. 22, 2018

(54) WIND TURBINE MAIN SHAFT BEARING AND METHOD OF UPGRADING A MAIN SHAFT BEARING

(71) Applicant: THE TIMKEN COMPANY, North Canton, OH (US)

(72) Inventors: Anthony Fierro, Uniontown, OH (US); Laurentiu C. Ionescu, Bucuresti (RO); Mihail E. Raducan, Ploiesti (RO); Michael J. Laughbaum, Bettendorf, IA (US); Kathleen Alexandridis, Charlotte, NC (US); Richard K. Brooks, Uniontown, OH (US); Douglas R. Lucas, Uniontown, OH (US)

(21) Appl. No.: 15/554,349

(22) PCT Filed: May 1, 2015
(86) PCT No.: PCT/US2015/028779

§ 371 Date: Aug. 29, 2017

(51) Int. Cl. F03D 80/70

(52) U.S. Cl. CPC F03D 80/70; F16C 35/047

(57) ABSTRACT

A wind turbine bearing system for a rotating main shaft of a wind turbine includes a double-row tapered roller bearing assembly (64) having a one-piece inner race element. The inner race element defines first and second inner raceways. The roller bearing assembly further includes first and second sets of tapered rollers seated within the corresponding first and second inner raceways. The bearing assembly also includes a two-piece outer race element, each piece of the two-piece outer race element defining a respective outer raceway. Each piece of the two-piece outer race element has a cylindrical outer diameter defining an outer contact surface. The system further includes a pillow block housing assembly that defines a cylindrical inner diameter (46) substantially matched to the outer contact surfaces (144,148) of the pieces of the two-piece outer race element to define an interface between the pillow block housing assembly and the bearing assembly.

### BACKGROUND

The present invention relates to a bearing system for use in supporting the main shaft of a wind turbine assembly.

In a modular gear drive wind turbine with a 3-point mount main rotor bearing arrangement, the main bearing must support the weight of the hub as radial load, along with thrust from the wind as an axial load, while accommodating overturning moments that result in dynamic misalignment. A spherical roller bearing is typically used in order to accommodate this combination of loads. Any thrust load not absorbed by the main bearing is transmitted through the gearbox carrier bearings to the torque arms, and then to the nacelle bedplate. Spherical roller main bearings in 3-point wind turbine models normally show significant wear and damage before their designed 20 year life. This damage often causes the main bearing to fail prematurely, but also results in the bearing losing its designed roller to raceway conformity, thus transmitting more of the system thrust into the gearbox. The gearbox planetary section often experiences increasing thrust damage over time as the main bearing wears.

### SUMMARY

The mechanism responsible for the life-limiting wear mode of micro-pitting that afflicts main shaft spherical roller bearings is roller/raceway sliding in low lambda conditions. These conditions are unavoidable for spherical roller bearings operating in main shaft pillow blocks of wind turbines. The present invention recognizes this shortcoming of spherical roller bearings in the wind turbine main shaft bearing application, and provides an improved solution, utilizing tapered roller bearings. The use of preloaded tapered roller bearings to replace spherical roller bearings results in improved system stiffness while still operating effectively in high misalignment conditions. The preloaded, double-row tapered roller bearing design facilitates proper load share between the two rows of rollers to help reduce or eliminate the roller/raceway sliding and skidding/smearing associated with conventional spherical roller bearing damage. The transmission of thrust loads to the gearbox is also minimized, resulting in longer main bearing life and less gearbox planetary section damage.

In one embodiment, the invention provides a wind turbine bearing system for supporting a rotating main shaft of a wind turbine. The system includes a double-row tapered roller bearing assembly having a one-piece inner race element defining an axial bore through which, in use, a rotating main shaft of a wind turbine passes. The one-piece inner race element defines first and second inner raceways on an outer diameter of the inner race element. The roller bearing assembly further includes first and second sets of tapered rollers, the first set of tapered rollers seated within the first inner raceway and the second set of tapered rollers seated within the second inner raceway. The bearing assembly also includes a two-piece outer race element, each piece of the two-piece outer race element defining a respective outer raceway on an inner diameter on which a corresponding set of the tapered rollers is seated. Each piece of the two-piece outer race element has a cylindrical outer diameter defining an outer contact surface. The system further includes a pillow block housing assembly configured for attachment to a stationary support structure. The pillow block housing assembly defines a cylindrical inner diameter substantially matched to the outer contact surfaces of the pieces of the two-piece outer race element to define an interface between the pillow block housing assembly and the bearing assembly.

In another embodiment, the invention provides a method of upgrading a wind turbine main shaft bearing system having a pillow block housing assembly configured for attachment to a stationary support structure, the pillow block housing assembly defining a bearing envelope around a bearing assembly installed in the pillow block housing. The method includes removing a double-row spherical roller bearing assembly from within the pillow block housing assembly and installing a double-row tapered roller bearing assembly into the pillow block housing assembly, such that once installed, the bearing envelope defined by the pillow block housing is unchanged or changed only for obtaining a desired preload on the double-row tapered roller bearing assembly.

Other aspects of the invention will become apparent by consideration of the detailed description and accompanying drawings.

### BRIEF DESCRIPTION OF THE DRAWINGS

FIG. 1 is a partial sectional view of a prior art pillow block bearing assembly for the main shaft of a wind turbine, the pillow block bearing assembly including a spherical roller bearing assembly.

FIG. 2 a partial sectional view of a pillow block bearing assembly embodying the present invention, and including a tapered roller bearing assembly.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

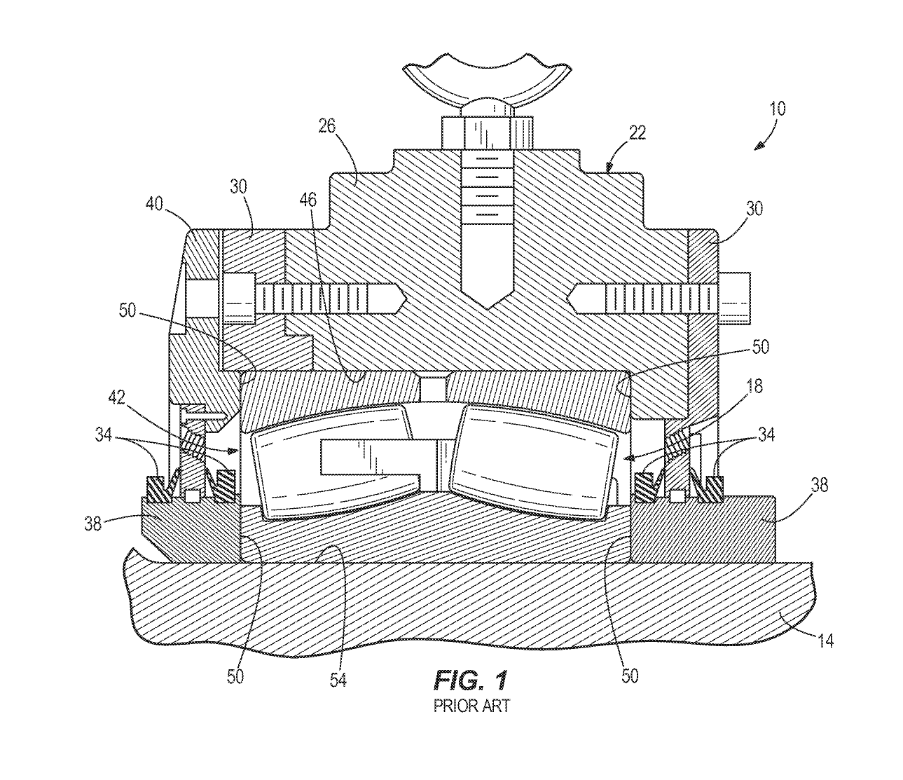

FIG. 1 illustrates an example of a prior art wind turbine bearing system 10 for supporting a rotating main shaft of a wind turbine. The turbine main shaft 14 is supported by a double-row spherical roller bearing assembly 18, which is housed within a pillow block housing assembly 22. The pillow block housing assembly 22 is configured to be attached to a stationary support structure of the wind turbine and can include multiple structural elements, including in the illustrated embodiment, a main housing portion 26 and elements attached to the main housing portion 26, such as end plates 30, seals 34, seal carriers 38, and a clamp ring 40. Together, the elements of the pillow block housing assembly 22 define an envelope 42 into which the spherical roller bearing assembly 18 fits. It is to be understood that while the section view of FIG. 1 illustrates only the portion of the bearing system 10 above the shaft 14, a mirror image exists below the shaft 14 defining the other half of the sectioned envelope 42. The illustrated portion of the envelope 42 is defined at its upper end by a cylindrical inner diameter surface 46 of the pillow block housing assembly 22, on its axial sides by axial inner surfaces 50 of the pillow block housing assembly 22, and at its lower end by the outer diameter 54 of the turbine main shaft 14. As seen in FIG. 1, the illustrated portion of the envelope 42 is generally rectangular in sectional shape.

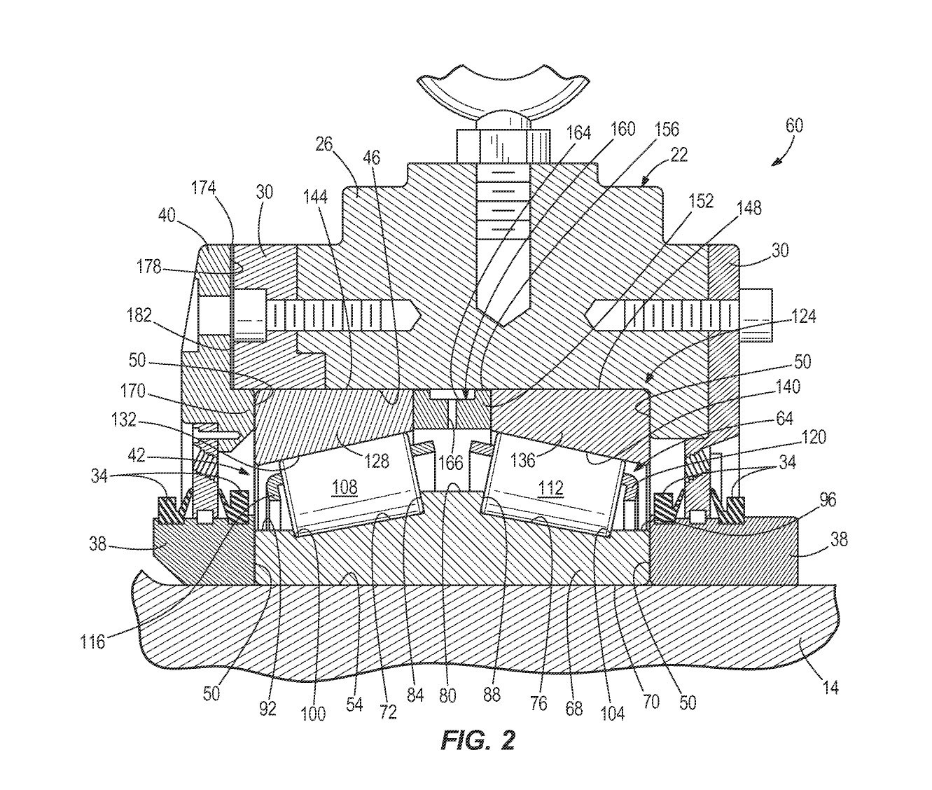

As discussed above, the prior art wind turbine bearing system 10 suffers from problems associated with the use of the spherical roller bearing assembly 18. FIG. 2 illustrates the wind turbine bearing system 60 of the present invention, in which the prior art spherical roller bearing assembly 18 is replaced by a double-row, tapered roller bearing assembly 64. The pillow block housing assembly 22 and the turbine main shaft 14 are unchanged, with like parts given like reference numerals. Therefore, according to the present invention, the tapered roller bearing assembly 64 is configured to fit within and occupy the existing envelope 42 provided by the prior art wind turbine bearing system 10 with no, or only slight, modification to the envelope 42, as will be explained in detail below. Likewise, it is understood that existing wind turbine bearing systems can have varying envelopes, yet the present invention contemplates designing a tapered roller bearing assembly to fit within and occupy substantially any existing envelope in a wind turbine bearing system that had previously utilized a double-row spherical roller bearing assembly.

The tapered roller bearing assembly 64 includes a one-piece inner race element 68 having an axial bore 70 through which, in use, the rotating main shaft 14 passes. The one-piece inner race element 68 defines first and second inner raceways 72, 76, respectively, on an outer diameter of the inner race element 68. The one-piece inner race element 68 includes a central rib 80 between the first and second inner raceways 72, 76, the central rib 80 defining a first shoulder 84 and a second shoulder 88. First and second outer ribs 92, 96, defining respective first and second outer rib shoulders 100, 104, are also formed on the inner race element 68. This one-piece inner race element 68 means that the tapered roller bearing assembly 64 is of the type commonly referred to as a tapered double inner (TDI) roller bearing assembly. The TDI indicator means that the inner race element 68 has two tapered raceways 72, 76 formed on a single or one-piece inner race element 68.

The tapered roller bearing assembly 64 further includes a first set or row of tapered rollers 108 and a second set or row of tapered rollers 112. The first set of tapered rollers 108 is seated on and within the first inner raceway 72 and the second set of tapered rollers 112 is seated on and within the second inner raceway 76. The rollers 108, 112 and raceways 72, 76, 132, 140 can be selectively radiused/crowned in order to account for the misalignment otherwise expected in other main shaft bearing systems. The first and second shoulders 84 and 88 are each in facing relation to axial ends of the respective first and second sets of tapered rollers 108, 112, with the central rib 80 sized and configured to selectively maintain the first and second sets of tapered rollers 108, 112 in position within the respective first and second inner raceways 72, 76. In the illustrated embodiment, a first retainer 116 positions the first set of tapered rollers 108 within the bearing assembly 64, and a second retainer 120 positions the second set of tapered rollers 112 within the bearing assembly 64.

The tapered roller bearing assembly 64 further includes a two-piece outer race element 124 having a first piece or outer ring 128 defining a first outer raceway 132 on its inner diameter, and a second piece or outer ring 136 defining a second outer raceway 140 on its inner diameter. The first set of rollers 108 ride on the first outer raceway 132, and the second set of rollers 112 ride on the second outer raceway 140 Each outer ring 128, 136 has a cylindrical outer diameter defining a cylindrical outer contact surface 144 and 148, respectively. The outer contact surfaces 144, 148 are substantially matched in diameter to the cylindrical inner diameter surface 46 of the pillow block housing assembly 22 so as to fit in the existing envelope 42. The interface between the cylindrical inner diameter 46 of the pillow block housing assembly 22 and the outer contact surfaces 144, 148 of the two-piece outer race element 124 can be a loose fit, a transition fit, or a tight fit as desired. Those fits, and the selected usage of those fits, are well-understood by those skilled in the bearing art.

The tapered roller bearing assembly 64 also includes a spacer 152 positioned between the two rings 128, 136 of the two-piece outer race element 124. The illustrated spacer 152 includes an outer diameter 156 that at least partially corresponds in size to the outer diameter defining the contact surfaces 144, 148 of each outer ring 128, 136. The outer diameter 156 of the spacer 152 further includes a recessed portion or annular groove 160 having an outer diameter 164 smaller than the outer diameter defining the contact surfaces 144, 148 of each outer race ring 128, 136. The annular groove 160 provides a channel for lubricant flow. Radial holes 166 (only one is shown) provide communication between the groove 160 and the rollers 108, 112 for greasing the bearing assembly 64.

In a prior design of a tapered roller bearing assembly to be used for a main shaft bearing application (described in U.S. Pat. No. 8,075,196), a generally spherical or ball-and-socket interface was provided between the outer bearing race element and the inner surface of the pillow block housing. This spherical interface was intended to accommodate misalignment, but resulted in the need for more complicated seals and perhaps an anti-friction liner at the interface. Unlike that prior assembly, which was a tapered double outer (TDO) roller bearing, the cylindrical interface between the cylindrical inner diameter 46 of the pillow block housing assembly 22 and the outer contact surfaces 144, 148 of the two-piece outer race element 124 does not require any modification to the envelope 42 (including the seals) used in existing prior art wind turbine bearing systems having spherical roller bearing assemblies. Thus, the present invention contemplates a drop-in replacement solution using a TDI tapered roller bearing assembly 64 configured to fit in existing envelopes 42.

Therefore, the invention also contemplates a method of upgrading a wind turbine main shaft bearing system by removing a double-row spherical roller bearing assembly 18 from within the pillow block housing assembly 22 and installing a double-row tapered roller bearing assembly 64 into the pillow block housing assembly 22 either without making any modifications to the pillow block housing assembly 22, or with minor modifications only for obtaining the desired preload on the bearing assembly. In the first situation, in which absolutely no modification is required, once the double-row tapered roller bearing assembly 64 is installed, the bearing envelope 42 defined by the pillow block housing 22 is unchanged from the configuration and size it defined when occupied by the double-row spherical roller bearing assembly 18.

In the second situation, in which a minor modification is made to the envelope 42 only for obtaining the desired preload on the bearing assembly 64, the clamp ring 40 may be adjusted to ever-so-slightly change the axial length of the envelope 42 adjacent the clamp ring 40. This modification is a minor surface machining operation to a surface of the clamp ring 40, in order to enable modification of the envelope 42 so slightly. Specifically, as shown in FIG. 2, the clamp ring 40 includes a finger portion 170 that defines an axial inner surface 50 of the clamp ring finger portion 170. The engagement between that axial inner surface 50 of the clamp ring finger portion 170 and the axial end of the first outer ring 128 dictates the positive clamp needed to establish the desired preloading of the bearing assembly 64. The engagement, and therefore the preloading, is facilitated by a gap 174 defined between a face surface 178 of the clamp ring 40 and a face surface 182 of the adjacent end plate 30 (or other portion of the pillow block housing assembly 22). This gap 174 may be about 0.2 mm so as to prevent the face surfaces 178 and 182 from engaging and “bottoming out” prior to the clamp ring 40 being sufficiently tightened down (via fasteners) for preloading the bearing assembly 64. In the event the desired preload cannot otherwise be achieved before the face surfaces 178 and 182 engage, the face surface 178 of the clamp plate 40 (or the face surface 182 of the end plate 30) may be machined to provide for the needed gap 174, and therefore the desired preload.

The amount of adjustment applied to the clamp ring 40, along with any machining of either of the face surfaces 178, 182 to allow for further tightening, can result in a slight alteration (i.e., increase or reduction) of the axial length of the envelope 42 adjacent the first outer ring 128, as compared to the original envelope 42 occupied by the spherical roller bearing assembly 18. This slight alternation ensures that the axial inner surface 50 defined by the finger portion 170 of the clamp ring 40 is in contact with the first outer ring 128 prior to face surfaces 178 and 182 engaging. As used herein and in the appended claims, reference to changes or modification(s) made to the envelope only for obtaining the desired preload on the bearing assembly means changes or modification(s) to the envelope of the above-described nature, for the sole purpose of achieving the desired preloading on the bearing assembly 64.

The use of preloaded tapered roller bearings to replace spherical roller bearings results in improved system stiffness while still operating effectively in high misalignment conditions. The preloaded, double-row tapered roller bearing design facilitates proper load share between the two rows of rollers to help reduce or eliminate the roller/raceway sliding and skidding/smearing associated with conventional spherical roller bearing damage. The preloaded, double-row tapered roller bearing design also minimizes the transmission of thrust loads to the gearbox, resulting in longer main bearing life and less gearbox planetary section damage.

Installing the double-row tapered roller bearing assembly 64 includes installing the one-piece inner race element 68 (with the first and second sets of tapered rollers 108, 112 and retainers 116, 120), and installing the two-piece outer race element 124 (with spacer 152) such that the cylindrical outer diameter defining the outer contact surfaces 144, 148 fits within the bearing envelope 42. In some situations, no modifications to the envelope 42, including those requiring machining or otherwise re-working the components of the pillow block housing assembly 22, are required. Alternatively, modifications may be made to the envelope 42 only for obtaining the desired preload on the bearing assembly 64.

It should be understood that while the illustrated embodiments show one example pillow block housing assembly 22 for a wind turbine that can be upgraded with a tapered roller bearing assembly 64, the present invention contemplates upgrading\replacing spherical roller bearing assemblies of different sizes used in virtually any prior art wind turbine pillow block housing assemblies. The replacement tapered roller bearing assembly can be sized to fit virtually any existing envelope, making upgrade/replacement easy.

Various features and advantages of the invention are set forth in the following claims.

1. A wind turbine bearing system for supporting a rotating main shaft of a wind turbine in a 3-point mount arrangement, the system comprising:
a double-row tapered roller bearing assembly, the double-row tapered roller bearing assembly including
a one-piece inner race element having an axial bore through which, in use, a rotating main shaft of a wind turbine passes to be supported in the 3-point mount arrangement, the one-piece inner race element defining first and second inner raceways on an outer diameter of the inner race element,
first and second sets of tapered rollers, the first set of tapered rollers seated within the first inner raceway and the second set of tapered rollers seated within the second inner raceway, and
a two-piece outer race element, each piece of the two-piece outer race element defining a respective outer raceway on an inner diameter on which a corresponding set of the tapered rollers is seated, each piece of the two-piece outer race element having a cylindrical outer diameter defining an outer contact surface; and
a pillow block housing assembly configured for attachment to a stationary support structure, the pillow block housing assembly defining a cylindrical inner diameter substantially matched to the outer contact surfaces of the pieces of the two-piece outer race element to define an interface between the pillow block housing assembly and the bearing assembly.

2. The wind turbine bearing system of claim 1, further comprising a spacer positioned between the two pieces of the two-piece outer race element.

3. The wind turbine bearing system of claim 2, wherein the spacer includes an outer diameter that at least partially corresponds in size to the outer diameter defining the contact surface of each outer race element piece.

4. The wind turbine bearing system of claim 3, wherein the outer diameter of the spacer further includes a recessed portion having an outer diameter smaller than the outer diameter defining the contact surface of each outer race element piece.

5. The wind turbine bearing system of claim 1, further comprising a first retainer positioning the first set of tapered rollers within the bearing assembly, and a second retainer positioning the second set of tapered rollers within the bearing assembly.

6. The wind turbine bearing system of claim 1, wherein the one-piece inner race element includes a central rib between the first and second inner raceways, the central rib defining a first shoulder in facing relation to axial ends of the first set of tapered rollers, and a second shoulder in facing relation to axial ends of the second set of tapered rollers, the central rib sized and configured to selectively maintain the first and second sets of tapered rollers in position within the respective first and second inner raceways.

7. The wind turbine bearing system of claim 1, wherein the interface between the cylindrical inner diameter of the pillow block housing assembly and the outer contact surfaces of the pieces of the two-piece outer race element is a loose fit.

8. The wind turbine bearing system of claim 1, wherein the interface between the cylindrical inner diameter of the pillow block housing assembly and the outer contact surfaces of the pieces of the two-piece outer race element is a transition fit.

9. The wind turbine bearing system of claim 1, wherein the interface between the cylindrical inner diameter of the pillow block housing assembly and the outer contact surfaces of the pieces of the two-piece outer race element is a tight fit.

10. The wind turbine bearing system of claim 1, wherein the pillow block housing assembly includes a clamp ring having a finger portion that engages the two-piece outer race element to preload the bearing assembly.

11. The wind turbine bearing system of claim 10, wherein a gap is defined between the clamp ring and an adjacent portion of the pillow block housing assembly, the gap permitting a desired preload to be applied to the bearing assembly by adjustment of the clamp ring.

12. A method of upgrading a wind turbine main shaft bearing system in a 3-point mount arrangement having a pillow block housing assembly configured for attachment to a stationary support structure, the pillow block housing assembly defining a bearing envelope around a bearing assembly installed in the pillow block housing, the method comprising:
removing a double-row spherical roller bearing assembly from within the pillow block housing assembly; and
installing a double-row tapered roller bearing assembly into the pillow block housing assembly, such that once installed, the bearing envelope defined by the pillow block housing is unchanged or changed only for obtaining a desired preload on the double-row tapered roller bearing assembly.

13. The method of claim 12, wherein installing the double-row tapered roller bearing assembly includes
installing a one-piece inner race element having an axial bore through which, in use, a rotating main shaft of a wind turbine passes to be supported in the 3-point mount arrangement, the one-piece inner race element defining first and second inner raceways on an outer diameter of the inner race element,
installing first and second sets of tapered rollers, the first set of tapered rollers seated within the first inner raceway and the second set of tapered rollers seated within the second inner raceway,
installing a first retainer positioning the first set of tapered rollers within the bearing assembly, and installing a second retainer positioning the second set of tapered rollers within the bearing assembly, and
installing a two-piece outer race element, each piece of the two-piece outer race element defining a respective outer raceway on an inner diameter on which a corresponding set of the tapered rollers is seated, each piece of the two-piece outer race element having a cylindrical outer diameter defining an outer contact surface configured to fit within the unchanged bearing envelope.

14. The method of claim 13, further comprising installing a spacer between the two pieces of the two-piece outer race element, the spacer including an outer diameter that at least partially corresponds in size to the outer diameter defining the contact surface of each outer race element piece.

15. The method of claim 12, wherein installing the double-row tapered roller bearing assembly into the pillow block housing assembly is completed without making any modifications to the pillow block housing assembly, such that once installed, the bearing envelope defined by the pillow block housing is unchanged.

16. The method of claim 12, wherein installing the double-row tapered roller bearing assembly into the pillow block housing assembly is completed with a modification made to the envelope only for obtaining the desired preload on the bearing assembly.

17. The method of claim 16, wherein the pillow block housing assembly includes a clamp ring having a finger portion that engages the bearing assembly to preload the bearing assembly, and wherein the modification made to the envelope includes only an adjustment made to the clamp ring.

18. The method of claim 17, wherein the adjustment made to the clamp ring alters the axial length of the envelope.

19. The method of claim 17, wherein the adjustment made to the clamp ring includes machining a surface of the clamp ring to maintain a gap between a surface of the clamp ring and a portion of the pillow block housing assembly.
